(19) United States
(12) Patent Application Publication
(10) Pub. No.: US 2018/0047257 A1
(43) Pub. Date: Feb. 15, 2018

(54) GAMING DEVICE HAVING MATRIX SYMBOLS AND REEL SYMBOLS

(71) Applicant: High 5 Games, LLC, New York, NY (US)

(72) Inventor: Uri Vasas, Brooklyn, NY (US)

(21) Appl. No.: 15/674,873

(22) Filed: Aug. 11, 2017

Related U.S. Application Data
(63) Continuation of application No. 62/373,773, filed on Aug. 11, 2016.

(51) Int. Cl. G07F 17/34; G07F 17/32

(52) U.S. Cl. CPC G07F 17/34; G07F 17/3244; G07F 17/3213; G07F 17/3267

(57) ABSTRACT

A game device comprising: a display device; an input device; and a processor for accessing a plurality of instructions which, when executed by the one processor, cause the at least one processor to operate with the at least one display device and the at least one input device to: provide a game comprising: a plurality of reels, each of the reels including a plurality of symbol positions; a symbol matrix having a plurality of symbol matrix positions; a random number generator to determine a stop position for each of the reels; a display of a portion of the reels in the symbol matrix positions determined by the corresponding stop reel stop positions; a display of at least one symbol attribute in the symbol matrix; a reward if a plurality of symbol attributes align in the symbol matrix; and an award if a winning combination of symbols is displayed in the symbol matrix.

### PRIORITY CLAIMS AND RELATED APPLICATIONS

This application is a continuation of U.S. Application No. 62/373,773, now pending, filed on Aug. 11, 2016.

### BACKGROUND

### Field of the Invention

Embodiments of the present disclosure generally relate to a gaming device having attributes of symbol matrix positions. More specifically, embodiments of the present invention generally relate to a slot machine having a number of attributes of symbol matrix positions that may align with each other to trigger a reward for a player.

### Description of Related Art

To play a conventional slot machine, a player deposits money in the form of coins, gaming tokens or paper currency either into a coin head or bill acceptor. The coins and gaming tokens are collected in a reservoir inside the gaming machine while the paper currency is collected in the bill acceptor inside the gaming machine. A processor validates the coins, gaming token, paper currency, or other form of credit as authentic. Once the processor authenticates the credits, the visual display shows the appropriate number of playing credits on a playing meter. The playing credits may be shown as a monetary amount, a number of spins, or some other multiplier of the monetary value deposited. For example, a twenty-five cent gaming machine will accrue four credits for each dollar that is deposited into the gaming machine.

After accruing credits on the credit meter, the player determines how many credits he wishes to wager or risk (the “stake”) on the next play of the game, which may include a spin of the slot reels. As used herein, a “reel” may include an arrangement of symbols. Traditional mechanical and electromechanical slot machines have a set of adjacent reels having symbols, numbers, pictures, or the like disposed in different positions on physical reels. Traditionally, mechanical or electromechanical slot machines include a number of rotating physical reels each having an outer circumferential reel strip printed with a number of play symbols usually consisting of items such as pictures of fruit, playing cards, other symbols, or the like. The reels are located in a side by side relationship for independent movement about a common axis. In the some electromechanical machines each of the reels are driven individually by a stepper motor that serves to rotate the reels about the common axis. In order to house the reels, conventional slot machines require a housing having a depth sufficient to accommodate the reels. These reels can be mounted on modules or reel mounting mechanisms which can each be separately inserted into the housing.

Reels and the Symbol Matrix

Slot symbols are located on multiple reels (also called columns) placed adjacent to each other. Reels can either be mechanical reels with fixed symbols located on the reels or an electronic simulation of the mechanical reels whereby the processor generates symbols on positions on the electronic reels. In most embodiments, there are at least three reels in the reel sets.

As slot game technology advanced, digital reel strips, or digital arrangements of symbols, became possible. Digital reel strips may be stored in memory and may include an arrangement of symbols. A visual representation of the reel strips may be displayed on a digital display, or the like, to simulate the visual effect of reels spinning as they would in a conventional mechanical or electromechanical slot game. The arrangement of symbols may include the possible game outcomes for a particular reel. Each reel may include one or more symbol matrix positions where one or more symbols may be located. An outcome generally includes the stopping point of one or more reels, which may be displayed to the player. A number of symbols on a reel may be displayed in accordance with its stopping point determined by a processor. In traditional mechanical or electromechanical slot gaming machines, a window or aperture would be present allowing the player to see a portion of the reels. The player would see the reels physically spin during gameplay and eventually terminate at a stopping point, wherein a certain number of symbols would be displayed in the window.

There are many advantages to using digital reels over physical reels. While physical reels are limited to the number of symbols that can physically fit on the reels, digital reel strips can include any suitable number of symbols, often in the hundreds or thousands. In some electronic slot games, reels are arranged in reel strips having a length set by an administrator, or the like. To play the game, after setting a wager, the player initiates the game for example, by spinning the reels mechanically or digitally. The game may be initiated by an input device by a player by pressing a spin button or touch screen option, by pulling a handle, and/or the like.

In mechanical or electromechanical slot machines, such player action, in turn, triggers the start of the reel motors which rotate the reels. In digital slot games, the spinning of the reels may be simulated. The reels may then stopped at random positions, usually under control of a microprocessor, or the like. The machine determines if a reward should be issued to the player in accordance with a pay table that may be configured by an administrator. For example, given combinations of the play symbols displayed along a pay line may result in an award to the player. In traditional slot games, each spin of the reels is typically a separate and distinct game, which has no relationship with any prior or future game played on that machine. In some games with digital reels, a game, outcome including a stop position for each of the reels, is determined by the microprocessor and a video or digital simulation of reels spinning and coming to a stopping point may be shown on a display. When the reels stop spinning, or the like, symbols are displayed on the display and the results of the game are presented to the user. The player then collects credits for winning combinations, if any, according to a pay table.

Slot game symbols may be located on one or more reels. Reels may be physical reels, digital reel strips, and/or the like. Digital reel strips may include an arrangement of symbols stored digitally, or the like. Symbols disposed on a physical reel physically spin when the reel spins. Some electronic slot machines include a processor working with a display to depict a simulation of a reel spinning, or the like. A slot game may include a processor, memory, and a display working together to display a digital representation of a physical reel after a player activates a game.

As used herein, the term “symbol” may refer to an indicia or indicator. At the conclusion of a game or spin, certain combinations of symbols may result in a reward for the player. In physical reels, symbols are displayed on the reel at various points around the outer circumference of the slot reel. Digital reels include various symbol positions, or positions on the reel strips where symbols are positioned. Reels may be placed or displayed adjacent to each other, and are often arranged in columns. In most embodiments, there are at least three reels in the reel sets and most often at least five.

The visual display includes a visible display area whereby a player can see a portion of the reels. The visual display area (also called a “symbol matrix”) displays a plurality of the reels and a portion of those reels. A typical example is a symbol matrix that displays three to five columns of three adjacent reels. In this typical example, the resulting symbol matrix is a rectangular display of symbols (nine symbols when three columns of three reels are visible and fifteen symbols when five columns of three reels are visible).

Within the symbol matrix, positions on the slot reels may be referred to according to column, from left to right, and row from top to bottom. For example, symbol position 1/2 if located in column 1 (left-most column) and row 2 (second row from the top). In some embodiments, the visible display area may be a non-rectangular shape. For example, the visible display may display one column of the first reel, two columns of the second reel, and one column of the third reel. In this example, four symbol matrix positions would be visible. In some embodiments, only one position on each reel is visible to a player. In some embodiments, multiple reels are vertically aligned and appear to be one column to the player. In some embodiments, only one symbol from each reel is visible (“independent reels”).

In some embodiments, there are hidden reels whereby none of the reel slots are visible. In some embodiments, the hidden reels become visible after a triggering event. The player collects credits for winning combinations based on the symbols displayed in the visible symbol matrix. In some embodiments, a player may collect additional credits for winning combinations based on symbols in non-visible positions on the reels or on symbols that are on hidden reels.

Winning Combinations.

Players collect credits for predetermined winning symbol combinations that appear in specific positions (pay lines) on the slot reels. Winning combinations typically require that three or more of the same symbols appear adjacent to each other starting from the leftmost position of a pay line (“line pays”). For example, a player may collect a line pay if three banana symbols appeared in symbol matrix positions 1/1, 2/1, and 3/1 on a pay line that includes symbol matrix positions 1/1, 2/1, 3/1, 4/1, and 5/1.

A player may wager on the occurrence of a winning combination on a single pay line or on the occurrence of a winning combination on multiple pay lines. Winning combinations may also occur when three or more of the same symbols appear adjacent to each other starting from the rightmost position of a pay line. Game rules may specify that some symbols may form winning combinations if there are two or more of the same symbol (“majors”) while other symbols may only form winning combinations if there are three or more of the same symbol.

Winning combinations may occur if three or more symbols appear on a pay line regardless of whether they are adjacent or regardless of whether the first occurrence of that symbol is in the leftmost or rightmost column. In some instances, there are wild symbols or substitute symbols that can be matched with other symbols. Players may also collect credits for predetermined winning combinations that appear anywhere on a pay line (“line scatter pays”) or anywhere on the symbol matrix positions (“reel scatter pays”). For example, a player may collect a line scatter pay if three banana symbols appeared in symbol matrix positions 1/1, 3/1, and 5/1 on a pay line using symbol matrix positions 1/1, 2/1, 3/1, 4/1, and 5/1; and collect a reel scatter pay if three banana symbols appear anywhere on the visible slot reels.

Pay Table.

Credits are awarded to the player for each winning symbol combination based on a predetermined schedule. For line pays and line scatter pays, the number of credits wagered on the winning pay line multiplies the number of credits indicated by the pay table. For example, a player may wager two credits each on five pay lines, spin the reels, and collect twice the amount indicated on the pay table for a line pay or line scatter pay appearing on any of the five played pay lines. For reel scatter pays, the total number of credits wagered multiplies the number of credits indicated by the pay table. For example, a player may wager ten total credits, spin the reels, and collect ten times the amount indicated on the pay table for a reel scatter pay appearing on anywhere on the symbol matrix positions.

Following any type of pay (e.g., line pays, line scatter pays, or reel scatter pays), credits won are added to the player's credit balance shown on the credit meter. As long as the player has credits on the credit meter, the player may continue to play the game. Following any spin, the player may collect the credit balance by pressing a Cash Out button. Credits may be paid out in many different ways. Credits can be paid out as cash or cash alternatives or as credits to play the game.

While the above elements are common to many slot machine games, without more, players are often easily bored by simple conventional game play. Therefore, there is a need for a gaming apparatus having an improved game play with attributes of symbol matrix positions that coordinate with each other to trigger a reward for a player.

### SUMMARY

Embodiments of the present disclosure generally relate to a gaming device having coordinating attributes of symbol matrix positions. In exemplary embodiments, each corner of a symbol position may have a chance of being “on” or may have a chance of being some portion of a symbol. An award of some type may be awarded if the attributes of symbol matrix positions line up/create a secondary symbol.

More specifically, embodiments of the present invention generally relate to a slot machine having attributes of symbol matrix positions that coordinate with each other to trigger a reward for a player.

In one embodiment, a game device comprises: a display device; an input device; and a processor for accessing a plurality of instructions which, when executed by the one processor, cause the at least one processor to operate with the at least one display device and the at least one input device to provide a game comprising a plurality of reels, each of the reels including a plurality of symbol matrix positions; a random generation of primary symbols and attributes of symbol matrix positions in the symbol matrix positions; at least one winning symbol combination comprising a predetermined number of attributes of symbol matrix positions displayed in alignment producing a reward for the player; and an award associated with the at least one winning symbol combination.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1A depicts a front perspective view of a gaming device in the form of a slot machine in accordance with one embodiment of the present invention;

FIG. 1B depicts a front perspective view of a gaming device in the form of a slot machine in accordance with another embodiment of the present invention;

FIG. 1C depicts a front perspective view of a gaming device in the form of a mobile device in accordance with one embodiment of the present invention;

FIG. 1D depicts a front perspective view of a gaming device in the form of a personal computer in accordance with one embodiment of the present invention;

FIG. 2A depicts a schematic block diagram of a computer system, which may be used with any of the gaming devices of FIGS. 1A-1D, in accordance with embodiments of the present invention;

FIG. 2B depicts a schematic block diagram illustrating a plurality of gaming terminals and communication with a central controller in accordance with one embodiment of the present invention;

FIG. 3A depicts a front elevation view of one of the display devices, illustrating one embodiment of the present invention;

FIG. 3B depicts a schematic diagram illustrating an exemplary award summary table associated with the embodiment of FIG. 3A;

FIGS. 3C and 3D depict front elevation views of one of the display devices illustrating an example of the embodiment of FIG. 3A;

FIG. 4 depicts a front elevation view of one of the display devices in accordance with another embodiment of the present invention, where the symbols on the reels include attributes of symbol matrix positions; and

FIG. 5 depicts a front elevation view of one of the display devices in accordance with another embodiment of the present invention, where the symbols on the reels include attributes of symbol matrix positions.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

In the following detailed description, numerous specific details are set forth in order to provide a thorough understanding of exemplary embodiments or other examples described herein. However, it will be understood that these examples may be practiced without the specific details. In other instances, well-known methods, procedures, and components have not been described in detail, so as to not obscure the following description. Furthermore, the examples disclosed herein are for exemplary purposes only and other examples may be employed in lieu of, or in combination with, the examples disclosed.

Embodiments of the present disclosure generally relate to a gaming device having symbols in both the reel positions and the symbol matrix positions. For example, in one embodiment, every corner of a symbol matrix position has the possibility of being covered by a fragment. In a preferred embodiment, each corner has a probability of being “on” or having a diamond-shaped fragment (i.e. a right triangle where the right angle is superimposed on the corner of the symbol). In this example, the game allows for the possibility of a full diamond showing up on the reels (i.e., if four symbols have their adjacent corners covered). The invention is not intended to be limited to diamond symbols, but rather, other symbols may also be used. This event can trigger a reward for the player (e.g. all reel symbols involved will turn wild, or the like. This feature may allow each symbol matrix position to have a secondary characteristic or attribute that may be beneficial to the player. As such, the player may not only “root” for the correct symbol to land but also may “root” to have the correct fragments in the symbol matrix.

Embodiments of the present invention generally relate to a slot machine having attributes of symbol matrix positions that coordinate with each other to trigger a reward for a player.

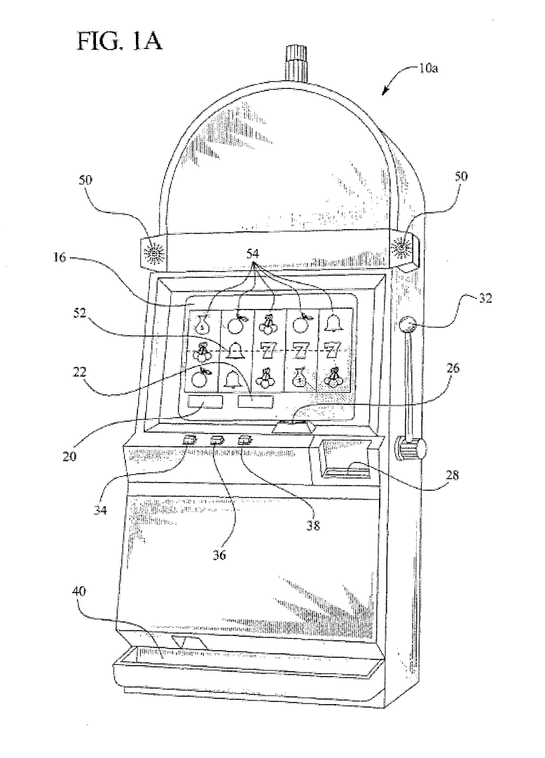

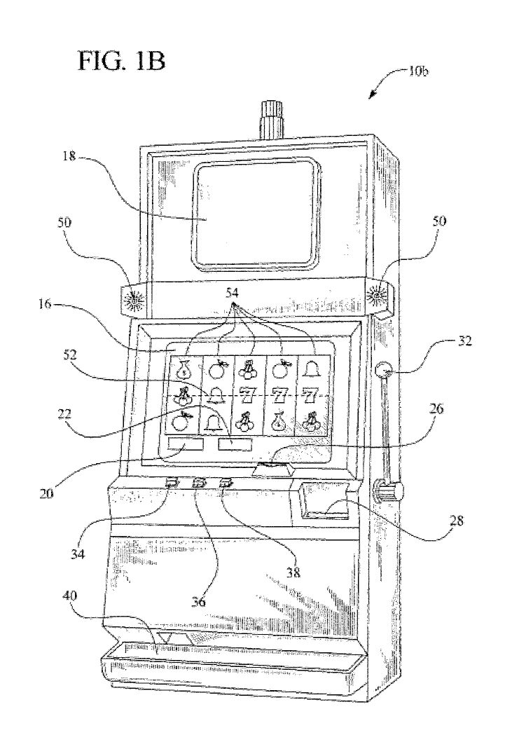

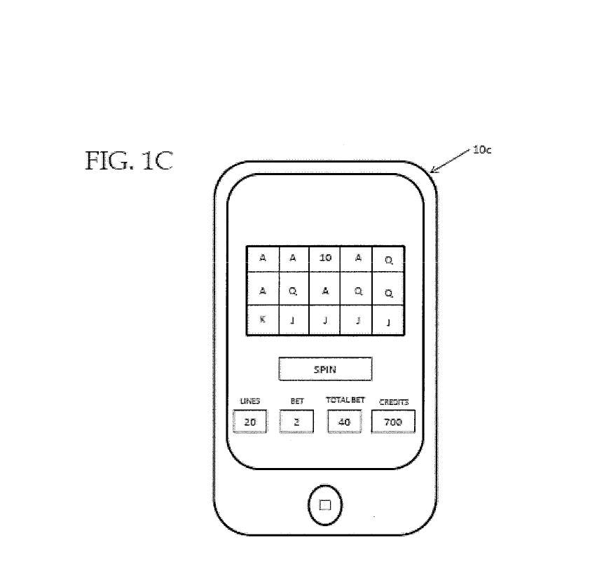

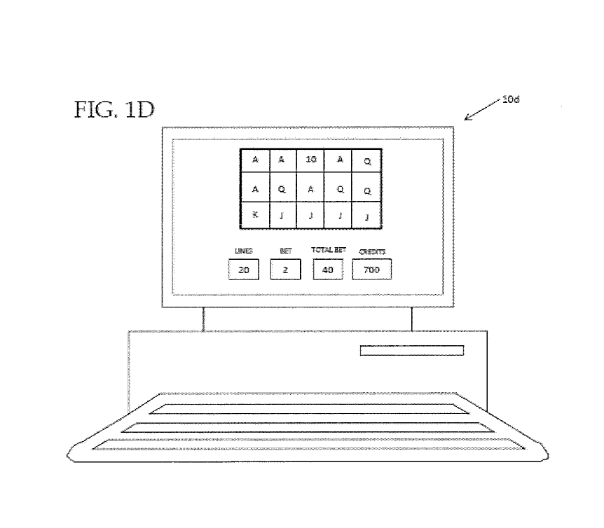

Two alternative embodiments of the gaming device of the present invention are illustrated in FIGS. 1A and 1B as gaming device 10a and gaming device 10b, respectively. Gaming device 10a and/or gaming device 10b are generally referred to herein as gaming device 10.

In one embodiment, as illustrated in FIGS. 1A and 1B, gaming device 10 has a support structure, housing or cabinet which provides support for a plurality of displays, inputs, controls and other features of a conventional gaming machine. It is configured so that a player can operate it while standing or sitting. The gaming device may be positioned on a base or stand or can be configured as a pub-style table-top game (not shown) which a player can operate preferably while sitting. As illustrated by the different configurations shown in FIGS. 1A and 1B, the gaming device can be constructed with varying cabinet and display configurations.

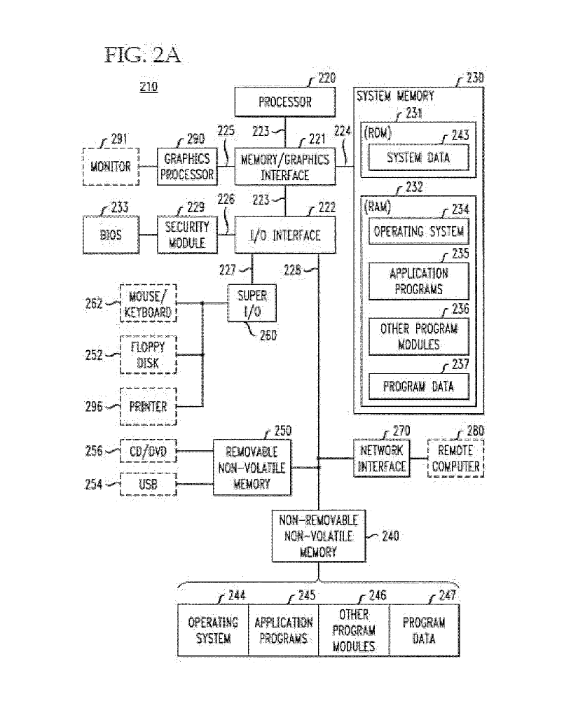

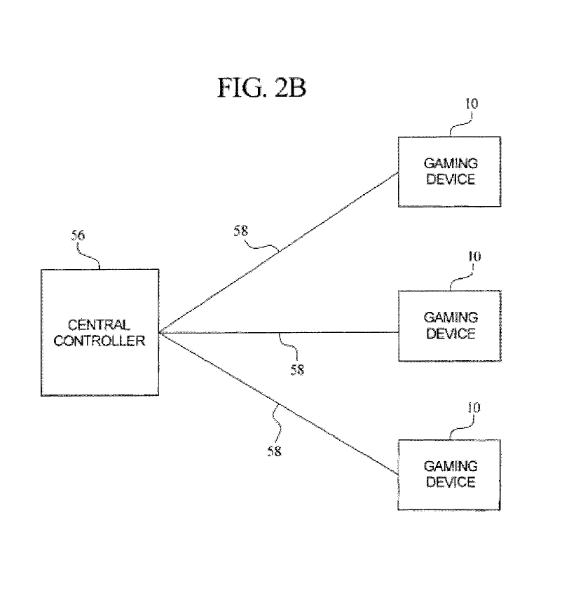

In several embodiments, the electronic gaming devices, for example, as shown in FIGS. 1A-1D, may comprise all or part of a computer system, for example, the computer system of FIG. 2. It should be appreciated, however, the computing system of FIG. 2 is merely an exemplary embodiment of an electronic device, and actual electronic devices may comprise any one or more components shown in FIG. 2A, suitable for embodiments of the present invention.

With reference to FIG. 2A, a computer system in the form of a computer 210 is shown. As understood by embodiments of the present invention, components shown in dashed outline are not part of the computer 210, but are used to illustrate the exemplary embodiment of FIG. 2A. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hyper transport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and can accessed by the computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other buses 226, 227 and 228 that couple a variety of internal and external devices to the computer 210. A serial peripheral interface (SPI) bus 226 may connect to a BIOS memory 233 containing the basic routines that help to transfer information between elements within computer 210, such as during start-up.

In some embodiments, a security module 229 may be incorporated to manage receipt of money/credits, issuance of money/credits, and enforcement of policies, as may be required in the gaming industry. In many embodiments, such security module 229 may be coupled with a payment acceptor built into a physical machine. A payment acceptor may include a coin slot and a payment, note or bill acceptor, where the player inserts money, coins or tokens. For example, the player can place coins in the coin slot or paper money, ticket or voucher into the payment, note or bill acceptor. In other embodiments, devices such as readers or validators for credit cards, debit cards or credit slips could be used for accepting payment. In one embodiment, a player may insert an identification card into a card reader of the gaming device. In one embodiment, the identification card is a smart card having a programmed microchip or a magnetic strip coded with a player's identification, credit totals and other relevant information. In one embodiment, money may be transferred to a gaming device through electronic funds transfer. When a player funds the gaming device, the processor determines the amount of funds entered and the corresponding amount is shown on the credit or other suitable display as described above.

A super input/output chip 260 may be used to connect to a number of ‘legacy’ peripherals, such as floppy disk 252, keyboard/mouse/buttons 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2A illustrates a hard disk drive 240 that reads from or writes to non-removable, nonvolatile magnetic media. Removable media, such as a universal serial bus (USB) memory 252 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media, discussed above and illustrated in FIG. 2A, provide storage of computer readable instructions, data structures, program modules and other data for the computer 210. In FIG. 2A, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum; they are different elements within the computer 210. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), an Ethernet-based network, a wide area network (WAN), or both, but may also include other networks. Such networking environments are commonplace in offices, enterprise-wide computer networks, intranets, and the Internet.

Returning to FIGS. 1A-1D, in one embodiment, as discussed in more detail below, the gaming device randomly generates awards and/or other game outcomes based on probability data. That is, each award or other game outcome is associated with a probability and the gaming device generates the award or other game outcome to be provided to the player based on the associated probabilities. In this embodiment, since the gaming device generates outcomes randomly or based upon a probability calculation, there is no certainty that the gaming device will ever provide the player with any specific award or other game outcome.

A random (or pseudorandom) number generator may be used to determine stop positions for the reels. The processor can use any known random number generator function known in the art such as those using the linear congruential generator which uses the recursive relation: Xₙ₋₁=(αXₙ+c) mod in where X is the sequence of pseudorandom values and m is the modulous, a is the multiplier, c is the increment, and X₀ is the seed value. It should be appreciated that other random or pseudo random number generators can be used including those that are built-in functions in java, c, c++, and the like.

In some embodiments, for each reel, the random number generator will return a number equal to or less than the number of symbols in that reel—a “stop position” for each reel. This number determines the final symbols to display in the symbol matrix. In some such embodiments, the number will correspond to a symbol position on the reels. The corresponding symbol position on the reels would then be the top symbol from a reel displayed in the symbol matrix. The game rules would determine how many symbols from that reel to display. This process is repeated for each reel. It should be appreciated that the random number generated can determine which symbol is in the bottom position, middle position, or the like. It should further be appreciated that often the reels will be stored in arrays beginning in zero and that a number generated may appear to be off by a set number from the randomly generated number.

In another embodiment, as discussed in more detail below, the gaming device employs a predetermined or finite set or pool of awards or other game outcomes. In this embodiment, as each award or other game outcome is provided to the player, the gaming device removes the provided award or other game outcome from the predetermined set or pool. Once removed from the set or pool, the specific provided award or other game outcome cannot be provided to the player again. This type of gaming device provides players with all of the available awards or other game outcomes over the course of the play cycle and guarantees the amount of actual wins and losses.

As shown by FIGS. 1A and 1B, and supported by the elements depicted in FIG. 2A, many embodiments of the present invention comprise at least one, and often a plurality, of input devices in communication with the processor. The input devices can include any suitable device which enables the player to produce an input signal which is read by the processor, for instructing the game and/or gaming device to do something. In one embodiment, after appropriate funding of the gaming device, the input device is a game activation device, such as a pull arm 32 or a play button 34 which is used by the player to start any primary game or sequence of events in the gaming device. The play button can be any suitable play activator such as a bet one button, a max bet button or a repeat the bet button. In one embodiment, upon appropriate funding, the gaming device begins the game play automatically. In another embodiment, upon the player engaging one of the play buttons, the gaming device automatically activates game play.

In one embodiment, as shown in FIGS. 1A and 1B, one input device is a bet one button 36. The player places a bet by pushing the bet one button. The player can increase the bet by one credit each time the player pushes the bet one button. When the player pushes the bet one button, the number of credits shown in the credit display preferably decreases by one, and the number of credits shown in the bet display preferably increases by one. In another embodiment, one input device is a bet max button (not shown) which enables the player to bet the maximum wager permitted for a game of the gaming device.

In one embodiment, one input device is a cash-out button 38. The player may push the cash out button and cash out to receive a cash payment or other suitable form of payment corresponding to the number of remaining credits. In one embodiment, when the player cashes out, the player receives the coins or tokens in a coin payout tray 40. In one embodiment, when the player cashes out, the player may receive other payout mechanisms such as tickets or credit slips redeemable by a cashier or funding to the player's electronically recordable identification card.

In one embodiment, one input device is a touch-screen coupled with a touch-screen controller, or some other touch-sensitive display overlay to allow for player interaction with the images on the display. The touch-screen and the touch-screen controller are connected to a video controller. A player can make decisions and input signals into the gaming device by touching touch-screen at the appropriate places.

In one embodiment, the gaming device includes a sound generating device controlled by one or more sound cards which function in conjunction with the processor. In one embodiment, the sound generating device includes at least one and preferably a plurality of speakers or other sound generating hardware and/or software for generating sounds, such as playing music for the primary and/or secondary game or for other modes of the gaming device, such as an attract mode. In one embodiment, the gaming device provides dynamic sounds coupled with attractive multimedia images displayed on one or more of the display devices to provide an audio-visual representation or to otherwise display full-motion video with sound to attract players to the gaming device. During idle periods, the gaming device may display a sequence of audio and/or visual attraction messages to attract potential players to the gaming device. The videos may also be customized for or to provide any appropriate information.

In one embodiment, the gaming machine may include a player or other sensor, such as a camera in communication with the processor (and possibly controlled by the processor) that is selectively positioned to acquire an image of a player actively using the gaming device and/or the surrounding area of the gaming device. In one embodiment, the camera may be configured to selectively acquire still or moving (e.g., video) images and may be configured to acquire the images in either an analog, digital or other suitable format. The display devices may be configured to display the image acquired by the camera as well as display the visible manifestation of the game in split screen or picture-in-picture fashion. For example, the camera may acquire an image of the player and that image can be incorporated into the primary and/or secondary game as a game image, symbol or indicia.

Suitable gaming devices may incorporate any suitable wagering primary or base game. The gaming machine or device of embodiments of the present invention may include some or all of the features of conventional gaming machines or devices. The primary or base game may comprise any suitable reel-type game, card game, number game or other game of chance susceptible to representation in an electronic or electromechanical form which produces a random outcome based on probability data upon activation from a wager. That is, different primary wagering games, such as video poker games, video blackjack games, video Keno, video bingo or any other suitable primary or base game may be implemented into an embodiment of the present invention.

In one embodiment, a base or primary game may be a slot game with one or more pay lines 52. The pay lines may be horizontal, vertical, circular, diagonal, angled or any combination thereof. In this embodiment, the gaming device displays at least one and preferably a plurality of reels 54, for example, having three to five reels 54 in either electromechanical form with mechanical rotating reels or video form with simulated reels and movement thereof. In one embodiment, an electromechanical slot machine includes a plurality of adjacent, rotatable wheels which may be combined and operably coupled with an electronic display of any suitable type. In another embodiment, if the reels 54 are in video form, the plurality of simulated video reels 54 are displayed on one or more of the display devices as described above. Each reel 54 displays a plurality of indicia such as bells, hearts, fruits, numbers, letters, bars or other images which may generally correspond to a theme associated with the gaming device. In this embodiment, the gaming device awards prizes when the reels of the primary game stop spinning if specified types and/or configurations of indicia or symbols occur on an active pay line or otherwise occur in a winning pattern.

In one embodiment, in addition to winning credits in a base or primary game, the gaming device may also give players the opportunity to win credits in a bonus or secondary game or bonus or secondary round. The bonus or secondary game enables the player to obtain a prize or payout in addition to the prize or payout, if any, obtained from the base or primary game. In general, a bonus or secondary game produces a significantly higher level of player excitement than the base or primary game because it provides a greater expectation of winning than the base or primary game and is accompanied with more attractive or unusual features than the base or primary game.

In one embodiment, the bonus or secondary game may be any type of suitable game, either similar to or completely different from the base or primary game. In one embodiment, the gaming device includes a program which will automatically begin a bonus round when the player has achieved a triggering event or qualifying condition in the base or primary game. In one embodiment, the triggering event or qualifying condition may be a selected outcome in the primary game or a particular arrangement of one or more indicia on a display device in the primary game, such as the number seven appearing on three adjacent reels along a pay line in the primary slot game embodiment seen in FIGS. 1A and 1B. In another embodiment, the triggering event or qualifying condition may be by exceeding a certain amount of game play (number of games, number of credits, amount of time), reaching a specified number of points earned during game play or as a random award.

In one embodiment, once a player has qualified for a bonus game, the player may subsequently enhance his/her bonus game participation through continued play on the base or primary game. Thus, for each bonus qualifying event, such as a bonus symbol, that the player obtains, a given number of bonus game wagering points or credits may be accumulated in a “bonus meter” programmed to accrue the bonus wagering credits or entries toward eventual participation in a bonus game. The occurrence of multiple such bonus qualifying events in the primary game may result in an arithmetic or geometric increase in the number of bonus wagering credits awarded. In one embodiment, extra bonus wagering credits may be redeemed during the bonus game to extend play of the bonus game.

In one embodiment, no separate entry fee or buy in for a bonus game need be employed. That is, a player may not purchase an entry into a bonus game; he must win or earn entry through play of the primary game and, thus, play of the primary game is encouraged. In another embodiment, qualification of the bonus or secondary game could be accomplished through a simple “buy in” by the player if, for example, the player has been unsuccessful at qualifying through other specified activities.

In one embodiment, as illustrated in FIG. 2B, one or more of the gaming devices 10 of embodiments of the present invention may be connected to each other through a data network or a remote communication link 58 with some or all of the functions of each gaming device provided at a central location such as a central server or central controller 56. More specifically, the processor of each gaming device may be designed to facilitate transmission of signals between the individual gaming device and the central server or controller.

In one embodiment, the game outcome provided to the player is determined by a central server or controller and provided to the player at the gaming device of an embodiment of the present invention. In this embodiment, each of a plurality of such gaming devices is in communication with the central server or controller. Upon a player initiating game play at one of the gaming devices, the initiated gaming device communicates a game outcome request to the central server or controller.

In one embodiment, the central server or controller receives the game outcome request and randomly generates a game outcome for the primary game based on probability data. In another embodiment, the central server or controller randomly generates a game outcome for the secondary game based on probability data. In another embodiment, the central server or controller randomly generates a game outcome for both the primary game and the secondary game based on probability data. In this embodiment, the central server or controller is capable of storing and utilizing program code or other data similar to the processor and memory device of the gaming device.

In an alternative embodiment, the central server or controller maintains one or more predetermined pools or sets of predetermined game outcomes. In this embodiment, the central server or controller receives the game outcome request and independently selects a predetermined game outcome from a set or pool of game outcomes. The central server or controller flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such as free games.

The central server or controller communicates the generated or selected game outcome to the initiated gaming device. The gaming device receives the generated or selected game outcome and provides the game outcome to the player. In an alternative embodiment, how the generated or selected game outcome is to be presented or displayed to the player, such as a reel symbol combination of a slot machine or a hand of cards dealt in a card game, is also determined by the central server or controller and communicated to the initiated gaming device to be presented or displayed to the player. Central production or control can assist a gaming establishment or other entity in maintaining appropriate records, controlling gaming, reducing and preventing cheating or electronic or other errors, reducing or eliminating win-loss volatility and the like.

In another embodiment, one or more of the gaming devices are in communication with a central server or controller for monitoring purposes only. That is, each individual gaming device randomly generates the game outcomes to be provided to the player and the central server or controller monitors the activities and events occurring on the plurality of gaming devices. In one embodiment, the gaming network includes a real-time or on-line accounting and gaming information system operably coupled to the central server or controller. The accounting and gaming information system of this embodiment includes a player database for storing player profiles, a player tracking module for tracking players and a credit system for providing automated casino transactions.

A plurality of the gaming devices are capable of being connected together through a data network. In one embodiment, the data network is a local area network (LAN), in which one or more of the gaming devices are substantially proximate to each other and an on-site central server or controller as in, for example, a gaming establishment or a portion of a gaming establishment. In another embodiment, the data network is a wide area network (WAN) in which one or more of the gaming devices are in communication with at least one off-site central server or controller. In this embodiment, the plurality of gaming devices may be located in a different part of the gaming establishment or within a different gaming establishment than the off-site central server or controller. Thus, the WAN may include an off-site central server or controller and an off-site gaming device located within gaming establishments in the same geographic area, such as a city or state. The WAN gaming system may be substantially identical to the LAN gaming system described above, although the number of gaming devices in each system may vary relative to each other.

In another embodiment, the data network is a global computer network, such as the Internet, or an intranet network, and the gaming system may be considered an online system, a mobile system, or the like. In this embodiment, the operation of the gaming device can be viewed at the gaming device with at least one web browser, or application, such that access to the data network is feasible. In this embodiment, operation of the gaming device and accumulation of credits may be accomplished with a connection to the central server or controller through a conventional phone or other data transmission line, digital signal line (DSL), T-1 line, coaxial cable, fiber optic cable, or other suitable connection. In this embodiment, players may access a game page from any location where a network connection and computer, or other gaming device 10, are available. For example, either of the gaming devices of FIGS. 1C and 1D are suitable for accessing such a data network.

The expansion in the number of computers and number and speed of internet connections in recent years increases opportunities for players to play from an ever-increasing number of remote sites. It should be appreciated that enhanced bandwidth of digital wireless communications may render such technology suitable for some or all communications according to some embodiments of the present invention, particularly if such communications are encrypted. Higher data transmission speeds may be useful for enhancing the sophistication and response of the display and interaction with the player.

In another embodiment, a plurality of gaming devices at one or more gaming sites may be networked to a central server in a progressive configuration, wherein a portion of each wager to initiate a base or primary game may be allocated to bonus or secondary event awards. In one embodiment, a host site computer is coupled to a plurality of the central servers at a variety of mutually remote gaming sites for providing a multi-site linked progressive automated gaming system. In one embodiment, a host site computer may serve gaming devices distributed throughout a number of properties at different geographical locations including, for example, different locations within a city or different cities within a state.

In one embodiment, the host site computer is maintained for the overall operation and control of the system. In this embodiment, a host site computer oversees the entire progressive gaming system and is the master for computing all progressive jackpots. All participating gaming sites report to, and receive information from, the host site computer. Each central server computer is responsible for all data communication between the gaming device hardware and software and the host site computer.

In some embodiments, the data network may be integrated into an existing network platform, for example, a social networking site. For example, in one embodiment, the data network may comprise an application within a social networking site, e.g., Facebook, whereby players may access the data network via a connection to the social networking site. Such an integrated arrangement may be advantageous for applications of embodiments of the present invention that seek to have near immediate access to a significant potential customer base.

In further embodiments, the data network may be accessed via a downloadable application to a mobile device, such as a smartphone, a tablet, a mobile computer, or the like. As is known in the mobile device industry, such a downloadable application may be stored at a remote server, and upon request, a player may utilize a mobile device to download such downloadable application to be stored locally on the mobile device. Such downloadable application may access the data network through the mobile device's network connection, and provide the player a convenient means through which to access the data network. In alternative embodiments, the downloadable application may not require a network connection on a regular basis, and a game may be accessible locally on the mobile device. However, in such embodiments, some of the benefits of networked game play, such as competitions, updates, etc., may not be available until the mobile device reconnects to the data network.

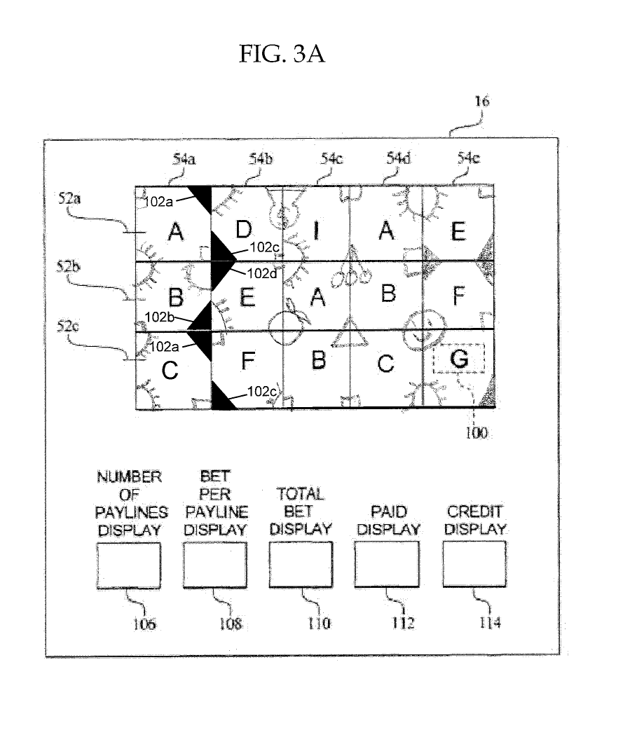

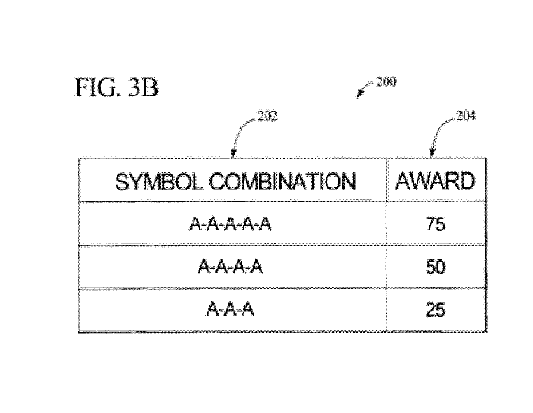

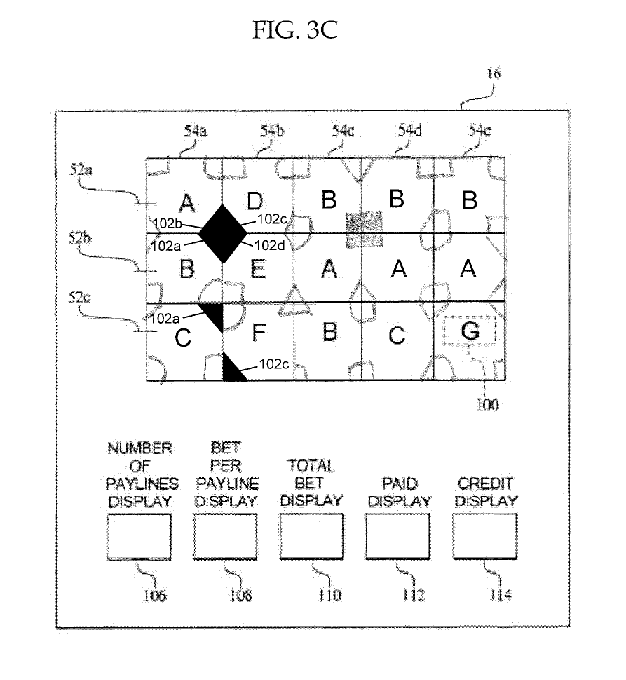

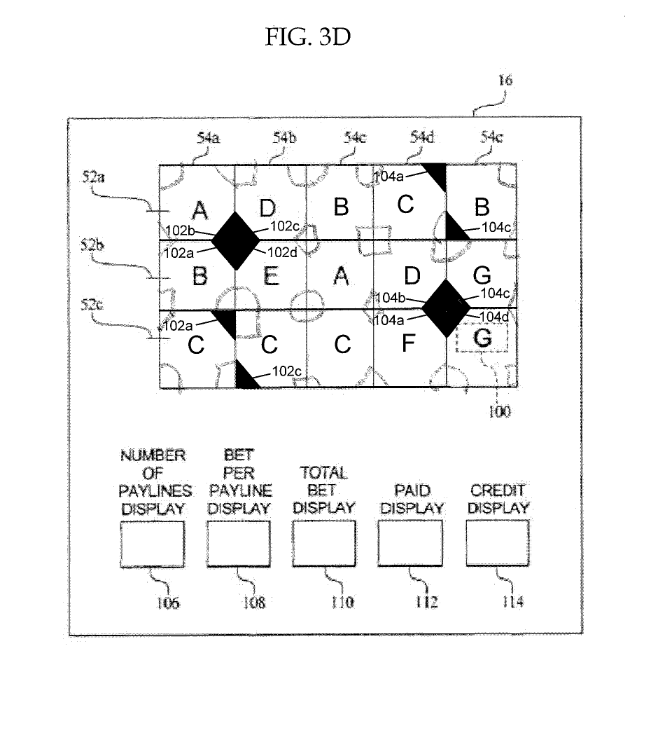

Referring now to FIG. 3A, an exemplary screen shot of a display of a gaming device is shown, in accordance with one embodiment of the present invention. As shown, a plurality of reels, such as reels 54a, 54b, 54c, 54d and 54e. In FIG. 3A, only a portion of the reels 54a, 54b, 54c, 54d, and 54e are in the symbol matrix. Each of the reels 54 includes at least one, and often a plurality, of reel symbol positions. The symbol matrix positions are the portions or areas on the reels where symbols are located and displayed to a player. Portions of the reels are shown on a symbol matrix, for example, symbol matrix position (3/2) refers to the position on the third reel (i.e., reel 54c) and the second position down in the matrix and the corresponding symbol position on the reel (i.e., the position including the A symbol) as determined by the random number generator as described above. The number of reels and symbol matrix positions depicted in the figures are merely examples, and other numbers of reels and/or symbol matrix positions suitable for embodiments of the present disclosure are contemplated.

Each of the symbol matrix positions may include an attribute 102ₐ, 102_{b}, 102_{c}, 102_{d}. For ease of description, only fragment attributes 102ₐ, 102_{b}, 102_{c}, 102_{d} are labeled with reference numbers, however additional symbol combinations (e.g., a “sun” symbol, a “square” symbol, a “group of cherries” symbol, and the like) are depicted and contemplated by and within embodiments of the present disclosure. Embodiments of the present disclosure may include any suitable attribute of symbols that may generate an award if the attributes line up, create a greater overlay, or the like. For example, each corner, or the like, of the symbol matrix position may have a chance of being “on” or have a chance of being some portion of a symbol and there is an award of some type if they line up/create a greater overlay.

In exemplary embodiments, the reels 54 include a plurality of symbols 100 which may include the letters A, B, C, D, E, F, G, and H, or the like. It should be appreciated that the reels may include any suitable symbols, attributes, characters or images as desired by the game designer. In one embodiment, each of the symbol positions on the reels includes a predetermined or designated symbol from the plurality of symbols. In another embodiment, each of the symbol positions on the reels includes a randomly determined symbol from the plurality of symbols, based on an algorithmic formula and distribution of symbols. It should be appreciated that any of the symbols may be in any of the symbol positions on the reels. In some embodiments, each of the symbol matrix positions includes a symbol attribute consistent with the present disclosure.

In some embodiments, the symbols 100 may optionally include at least one split symbol or replicator symbol, for example, as disclosed by U.S. Pat. No. 7,402,102, and incorporated by reference herein in its entirety. Each replicator symbol includes at least two symbols from the plurality of symbols at a single symbol position on the reels. Each replicator symbol may include at least two of the same symbols or identical symbols at a single symbol position. In another embodiment, the replicator symbols include at least two symbols from the plurality of symbols where at least one of the symbols associated with the replicator symbol is different. The replicator symbols provide additional symbols on the reels and therefore enhance the probability that a winning symbol combination or combinations will occur on the reels. In one embodiment, the gaming device provides an outcome such as one or more awards, prizes, credits, free spins, free games, game elements or any other suitable award to a player when a designated symbol combination including at least two of the symbols is indicated in at least one of the symbol matrix positions on the reels 54.

In one embodiment a plurality of paylines such as paylines 52a, 52b and 52c are associated with the symbol matrix positions. In one embodiment, the gaming device provides an outcome to the player when a designated combination of symbols such as a winning combination of symbols is indicated in at least one symbol matrix position on one of the paylines 52a, 52b or 52c. In another embodiment, the gaming device provides the outcome to the player when the winning symbol combination is indicated in at least one symbol position on a plurality of the paylines. In a further embodiment, the gaming device provides the outcome to the player when a winning symbol combination is indicated in at least one symbol position on any of the paylines associated with the reels. It should be appreciated that a designated combination of symbols or a winning symbol combination may be a line pay, a line scatter pay, a reel scatter pay or any suitable winning combination of the symbols.

In one embodiment, the gaming device includes a set of meters or displays used to display the relative information for the game, including the number of credits, number of pay lines, amount bet per line, total bet, and the amount paid to the player in a spin of the reels. If necessary, any number of meters may be added to further facilitate control of the games.

In another embodiment, the number of credits in the credit pool is displayed by a credit meter or credit display 114. The pool of credits increases and decreases according to the player's wins or losses in a game and may be supplemented, if necessary, by the player when the player deposits additional coins, tokens or paper currency into the gaming device.

In yet another embodiment, the number of pay lines upon which the player wagered in a game is displayed on a Number of Pay Lines meter or display 106. The pay lines are activated in a predetermined order, as follows: the first wager is applied to pay line 52a; the second wager is applied to pay line 52b; and the third wager is applied to pay line 52c. However, the games may have fewer or greater than three pay lines and activate the paylines in any suitable order.

In a further embodiment, the number of credits wagered on each pay line is displayed on a Bet Per Line display. In this embodiment, the same amount is wagered on each of the pay lines. Alternatively, in another embodiment the player could wager different amounts on each pay line in a game.

In one embodiment, the total number of credits bet on all of the pay lines is displayed by a Total Bet display 110. The total bet is calculated by multiplying the number of pay lines by the bet per line. In addition, the number of credits awarded for any winning symbol combinations is displayed by a Paid display 112.

In exemplary embodiments, symbol matrix positions may occupy portions of symbol matrix position corners. Fragments 102 may be associated with each of the symbol matrix positions corners or the like. Attributes of symbol matrix positions 102 may generally comprise two or more partial portions of a larger complete object. In some embodiments, the attributes of the symbol matrix positions may be disposed in each of the four corners of the symbol position, or the like. An attribute of symbol matrix position 102 may be assigned to and/or displayed in each symbol position 100 by the gaming device, or the like. A fragment 102 may be randomly generated by the gaming device with a randomization algorithm and may be associated with and/or displayed on one or more symbol matrix positions with a main or primary symbol 100. For example, in FIG. 3A, symbol matrix positions 1/1, 1/2, 1/3, 2/1, 2/2, and 2/3, depict various fragments 102a, 102b, 102c, and 102d sharing symbol matrix positions with primary/reel symbols 100 (i.e., “A”; “B”; “C”; “D”; “E”; and “F”) from the reels.

When the fragments complete objects, align with each other or otherwise coordinate with each other to form the complete object after the reels are spun in accordance with exemplary embodiments, a reward may be generated for the player. A reward may comprise an advantage or benefit for the player, such as turning all symbols that form a complete object into “wild” symbols, multiplying or otherwise increasing the payout, upgrading symbols, issuing a bonus or free spins, and/or the like. A complete object may generally comprise one or more fragments 102 in alignment with each other, or the like.

In some embodiments, the complete object may comprise a picture, a logo, a design, a symbol, a pattern, and/or the like. By way of example, the fragments 102 shown in FIG. 3A align to form a diamond shape, or the like (See FIGS. 3C and 3D).

In some embodiments, the symbol matrix positions or a portion thereof (e.g. the corners) each symbol matrix position, or portion thereof, may be turned “on” or “off” based on random selection, coordinated random selection, or the like. Each fragment of each symbol matrix position may have a chance of being some portion of a symbol and may generate an award if the fragment lines up with fragment of a second symbol matrix position and/or creates a greater symbol, or the like.

In accordance with exemplary embodiments, the fragments of symbol matrix positions 102 may comprise at least two coordinating smaller portions of a larger object, overlay, or the like. For example, if the larger object is an image or symbol depicting a heart, the heart may be displayed across two symbol matrix positions. When the two symbol matrix positions are displayed adjacent to each other and aligned, the complete object may be displayed. For example, two portions of a heart symbol, or the like, may displayed on adjacent symbol matrix positions, the first portion on a right side of a first symbol position and the second portion on a left side of a second symbol position. After the reels are spun in accordance with embodiments of the present invention, when the two portions of the heart symbol are selected to be “on”, the complete object is displayed, thereby producing a reward for the player.

In exemplary embodiments, corresponding fragments or attributes of symbol matrix positions are generally displayed in adjacent symbol matrix positions in opposite positions. For example, an fragment of symbol position may comprise a first portion of an image disposed on a bottom side of a first symbol position and a corresponding second portion of the image may be disposed on a top side of a second symbol position, and/or the like. In the embodiment depicted in FIGS. 3A-3C, four portions of a diamond are displayed in a number of different positions on four different symbol matrix positions. Although four portions of a complete object are depicted in the figures, attributes of symbol matrix positions may be displayed in any number of portions from two symbol matrix positions to the symbol matrix positions comprising the entire display area. For example, a complete object may be formed by two, four, six, eight, and/or the like different symbol matrix positions.

In the exemplary embodiment depicted in FIG. 3A, the attributes of symbol matrix positions are depicted in a configuration that displays no more than two attributes of symbol matrix positions as being in alignment with each other (e.g., symbol matrix positions 1/2 and 1/3 and symbol matrix positions 2/1 and 2/3). A game may require all four attributes of symbol matrix positions 102a, 102b, 102c, and 102d to be displayed in alignment with each other to produce a bonus. In such an embodiment the player would not receive a reward according to the result depicted in FIG. 3A because no more than two adjacent attributes of symbol matrix positions are selected to be turned on. In alternative embodiments, if less than all of the attributes of symbol matrix positions making up a complete object are displayed in alignment with each other, a smaller reward may be awarded.

In the embodiment depicted in FIGS. 3A-3C, the corner of each symbol position may have the possibility of being covered by a right triangle, wherein the right angle of each right triangle is superimposed on the corner of the symbol position. This produces the possibility of a full diamond being displayed on the reels if four displayed symbols have their adjacent corners covered. When a full diamond is displayed, this event can trigger a reward for he player (e.g. all symbols displaying a portion of the complete diamond will turn wild). This feature may allow each symbol to have a secondary characteristic that might be beneficial to the player, which may include rewards such as wild, split symbols, the same symbol, start of a bonus game, lock in place, stay in place a certain number of rounds, creates an additional attribute or symbol, and/or the like. As such, an additional element of excitement may be added to the game as the player is interested and rooting for both primary symbols 100 and attributes of symbol matrix positions 102 to align.

Referring now to FIG. 3B, winning combinations may be defined by pay tables or award summary tables associated with a game. The pay tables define the winning symbol combinations for a game such as a winning symbol combination including three or more of the same symbols on a pay line. Each symbol in a symbol position counts towards the total number of symbols on a pay line. In addition, a pay table may also define scatter awards for winning symbol combinations including symbols scattered anywhere on the symbol matrix positions. Alternatively, any predetermined or designated arrangement of symbols may be defined as a winning symbol combination in a game and any suitable number of awards or credits may be provided to a player for the winning symbol combinations.

As shown in the Figure, the payout table or award summary table 200 indicates the winning symbol combinations 202 and the awards or credits associated with each of those winning symbol combinations. The award summary table 200 shows exemplary winning symbol combinations for one of the symbols, the letter A, and the awards associated with that symbol. In this example, all of the symbols on the reels include the same winning symbol combinations and the same awards associated with those winning symbol combinations. For example, a winning symbol combination including the letter C provides the same award as a winning symbol combination including the letter A when the winning symbol combination is indicated in at least one of the symbol matrix positions on a payline associated with the reels. It should be appreciated that the designated symbol combinations or winning symbol combinations in the game may include any suitable combination of the same symbols or different symbols in the game. In addition, it should be appreciated that the winning symbol combinations may provide any suitable awards, prizes, free games, free spins, game elements or any other suitable award, awards or outcomes in the game.

To operate and play the game, a player initially inserts currency into the game and obtains a number of credits as indicated by the credit display 114. The player begins playing the game by depressing the select paylines button to increase the number of paylines wagered in the game from one to three as indicated by the number of paylines display 106. In this example, there are three paylines 52a, 52b and 52c associated with the reels 54.

Next, the player may press the bet per payline button to increase their bet or wager on each payline from one to three credits as indicated by the bet per payline display 108. Therefore, the player may wager three credits on each of the paylines 52a, 52b and 52c. Based on the wager made by the player in this spin or activation of the reels in the game, a total bet or wager is indicated by the total bet display 110. The total bet equals the number of paylines wagered on by the player of three multiplied by the amount bet per payline by the player. Because the game has not started yet the pay display may indicate a zero or that the player has not received any awards or credits in the game. The total bet made by the player in an activation or spin of the reels is subtracted from the player's total credits in the game which results in the new total number of credits being indicated by the credit display 114.

Referring to FIG. 3C, the gaming device or player presses or activates a play button 34 or pull arm 32 (shown in FIGS. 1A and 1B) to activate or spin the reels for the first time in the game. The reels stop and display a plurality of symbols in the symbol matrix positions on the reels 54. Specifically, the reels or symbol matrix on the reels includes a winning symbol combination at the symbol matrix positions on paylines 52a and 52b associated with reels 54a, 54b, 54c, 54d and 54e. In this example, a diamond is formed by the attributes of symbol matrix positions 102a, 102b, 102c, and 102d that are selected to be turned “on” and displayed in alignment with adjacent symbols. In some examples, when a complete object, such as a diamond depicted in FIG. 3C, all symbols displaying the complete object may be turned wild. In this example, the winning symbol combinations includes five B symbols in payline 52a and 5 A symbols in payline 52b. The winning combination formed by symbol positions 1/1, 1/2, 2/1, and 2/2. According to the pay table or award summary table 200 in FIG. 3B, a winning symbol combination including five symbols pays 75 credits for each credit wagered upon payline 52a. The award is then added to the player's total credits and gives the player a new total number of credits that is indicated by the credit display 114.

In some embodiments, when fragments or attributes of symbol matrix positions match, a reel symbol shown in the symbol matrix positions is replicated across all “matched” symbol matrix positions. In these embodiments, a player may select which symbol to replicate, the processor may replicate the most valuable symbol, the processor may replicate the symbol that would issue the highest award, or the like.

Referring to FIG. 3D, two additional reels 52d and 52c are provided with the possibility of forming a complete object. The gaming device or player may activate or spin the reels and the player may wager on the maximum number of paylines, as indicated by the number of paylines display 106. The total bet is subtracted from the credit display to give the player a total number of credits before their spin. The gaming device or player activates or spins the reels and when the reels stop, a plurality of symbols are indicated in the symbol matrix positions on the reels and two complete diamonds are formed.

Specifically, in this example, a winning symbol combination including four B symbols in payline 52a, five A symbols in payline 52b, and five C symbols in payline 52c. The winning symbol combination including three B symbols provides a payout or award of two hundred. The credit meter 114 may then up to reflect the award obtained by the player in that spin.

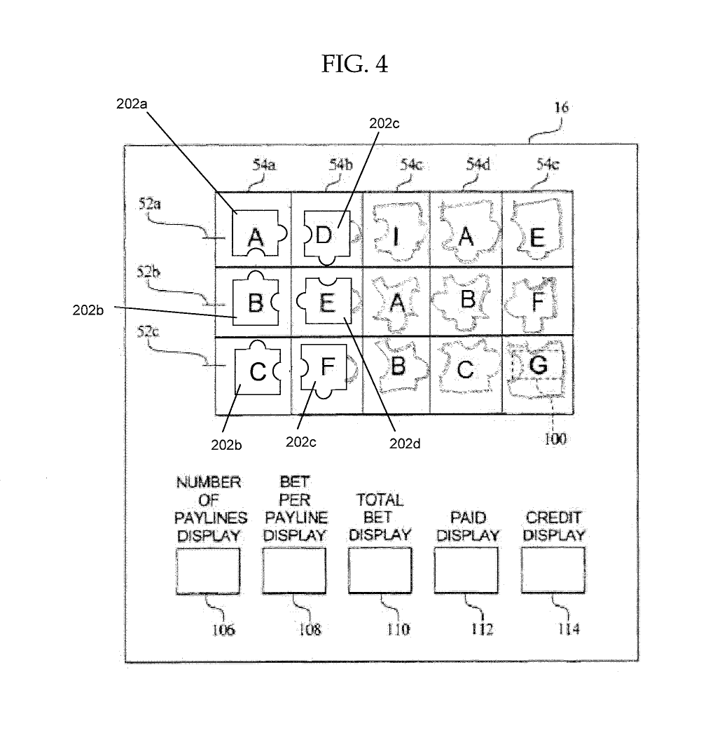

FIG. 4 depicts another embodiment of the present invention where the symbols include attributes of symbol matrix positions 202a, 202b, 202c, 202d depicting puzzle pieces instead of a diamond. Not all attributes of symbol matrix positions are labeled in the figure, this is done merely for ease of description and it is contemplated that every symbol matrix position may comprise attributes and can align with additional attributes to generate a benefit or award to the player. In this embodiment, the puzzle piece attributes 202a, 202b, 202c, 202d may align and coordinate with each other to form to complete a puzzle. In some embodiments, a random puzzle piece symbol or attribute is assigned to symbol matrix positions and a reward is given if the pieces fit together with the puzzle piece in an adjacent symbol matrix position. It should be appreciated that in some embodiments, attributes will appear in adjacent symbol matrix position, but not align with each other and therefore not produce a benefit to the player. In some other embodiments, there are set attributes for each symbol matrix position, and whether the attribute is visible or “on” is determined by randomization and adjacent visible attributes in symbol matrix positions will produce a benefit.

In the example depicted in FIG. 4, symbol matrix positions 1/1, 1/2, 2/1, and 2/3 align to complete the puzzle. Any number of puzzle pieces across any suitable number of symbol matrix positions is contemplated. In one embodiment, the gaming device provides a bonus outcome such as a bonus award to the player when at least two of the attributes of symbol matrix positions are turned on and aligned. In another embodiment, the gaming device provides the bonus outcome to the player when at least four of the attributes of symbol matrix positions are turned on and aligned. The attributes of symbol matrix positions in alignment provides the player with an additional outcome or outcomes in a game such as an additional award or awards, which increases the player's excitement and enjoyment of the game. It should be appreciated that the attributes of symbol matrix positions may form any suitable symbol, character or image desired by the game implementer. It should also be appreciated that the bonus outcome may include awards, prizes, credits, free spins, free games, game elements or any other suitable outcome.

It should be appreciated that game rules may dictate larger rewards for increased attribute matches. For example, a game may award a 2× multiplier when two attributes align; a 3× multiplier when three attributes align; a 4× multiplier when four attributes align, and so forth.

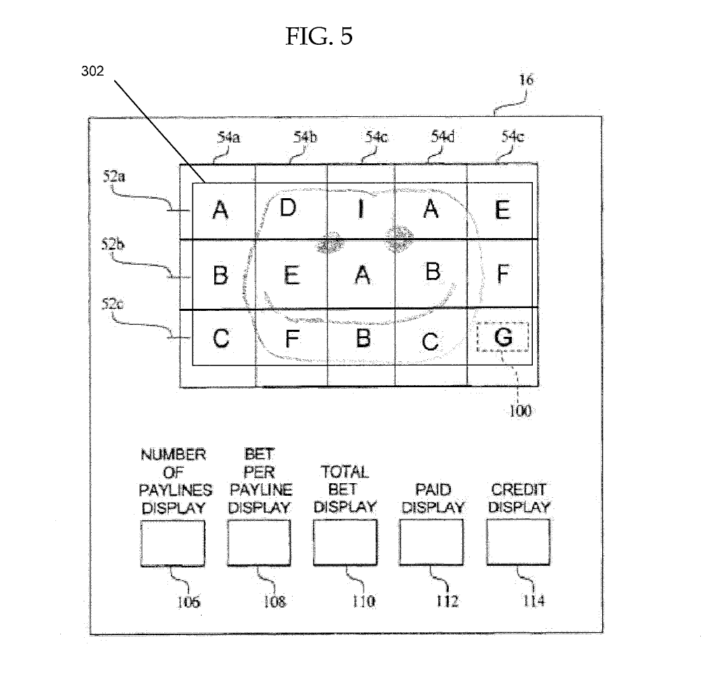

FIG. 5 depicts another embodiment of the present invention where the symbols include a single outer perimeter line 302 across the entire outside perimeter of the symbol matrix positions. In this embodiment, the symbol matrix positions on the outer perimter may align and coordinate with each other to form to complete a puzzle. In this example, the attributes are turned on and align to form a “smiley face” symbol. This embodiment is included to illustrate that more than four symbol matrix positions may potentially coordinate together to form a complete object and provide the player with a reward in accordance with embodiments of the present disclosure. In some embodiments, every symbol position may potentially coordinate to form a large complete object comprising all symbol matrix positions, or the like.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. For example, an element disclosed by one embodiment of the present invention may be included in any other disclosed embodiment, where suitable. All such modifications and variations are intended to be included herein within the scope of this disclosure and the present invention.

What is claimed is:

1. A game device comprising:
a display device;
an input device; and
a processor for accessing a plurality of instructions which, when executed by the one processor, cause the at least one processor to operate with the at least one display device and the at least one input device to:
provide a game comprising:
a plurality of reels, each of the reels including a plurality of symbol positions;
a symbol matrix having a plurality of symbol matrix positions;
a random number generator to determine a stop position for each of the reels;
a display of a portion of the reels in the symbol matrix positions determined by the corresponding stop reel stop positions;
a display of at least one symbol attribute in the symbol matrix;
a reward if a plurality of symbol attributes align in the symbol matrix; and
an award if a winning combination of symbols is displayed in the symbol matrix.

2. The game device of claim 1 wherein the symbols in the symbol matrix positions with aligned symbol attributes are modified to wild symbols.

3. The game device of claim 1 wherein the symbols in the symbol matrix positions with aligned symbol attributes are modified to match each other.

4. The game device of claim 1 wherein the reward is a bonus game.

5. The game device of claim 1 wherein the reward is free games.

6. The game device of claim 5 wherein the number of free games depends on the number of aligned attributes.

7. The game device of claim 1 wherein the reward is to increase a multiplier for the award.

8. The game device of claim 7 wherein the multiplier is increased by the number of aligned attributes.

9. A method of making a game comprising:
displaying a plurality of a portion of reels on a symbol matrix wherein the reels have a plurality of reel symbol positions, each reel symbol position has a symbol;
displaying at least one symbol matrix attribute in the symbol matrix;
issuing a reward if symbol matrix attributes align in the symbol matrix; and
issuing an award if a winning symbol combination of symbols is displayed in the symbol matrix.

10. The method of claim 9 wherein the reward is to modify the symbols in the symbol matrix positions with aligned attributes are changed to wild symbols.

11. The method of claim 9 wherein the reward is to modify the symbols in the symbol matrix positions with aligned attributes are changed to match each other.

12. The method of claim 9 wherein the reward is a bonus game.

13. The method of claim 9 wherein the reward is free games.

14. The method of claim 13 wherein the number of free games depends on the number of aligned attributes.

15. The method of claim 9 wherein the reward is to increase a multiplier for the award.

16. The method of claim 15 wherein the multiplier is increased by the number of aligned attributes.

17. A slot game comprising:
a display device;
an input device detecting a command to initiate game play;
a processor;
a plurality of reels, each of the reels including a plurality of symbol positions;
a random number generator to determine a stop position for each of the reels;
a symbol matrix on the display device having a plurality of symbol matrix positions;
a display of a portion of the reels in the symbol matrix positions determined by the corresponding stop reel positions;
a display of at least one symbol attribute in the symbol matrix;
a reward if a plurality of symbol attributes align in the symbol matrix; and
an award if a winning combination of symbols is displayed in the symbol matrix.

18. The slot game of claim 17 wherein there are multiple symbol attributes for each symbol matrix position.

19. The slot game of claim 17 wherein the reward is to modify the symbols in the symbol matrix positions with aligned symbol matrix attributes to be wild symbols.

20. The slot game of claim 17 wherein the reward is to modify the symbols in the symbol matrix positions with aligned symbol matrix attributes to match each other.
